(19) United States
(12) Patent Application Publication
(10) Pub. No.: US 2012/0249882 A1
(43) Pub. Date: Oct. 4, 2012

(54) COMMUNICATION MODULE AND COMMUNICATION SYSTEM

(75) Inventors: Yoshinori Satoh, Saitama (JP); Takashi Tsurumoto, Saitama (JP); Kazunori Kikuchi, Kanagawa (JP); Naoki Sugita, Tokyo (JP)

(73) Assignee: SONY CORPORATION, Tokyo (JP)

(21) Appl. No.: 13/429,646

(22) Filed: Mar. 26, 2012

(30) Foreign Application Priority Data
Apr. 1, 2011 (JP) 2011-081615

(51) Int. Cl. H04N 5/63; H04N 5/38

(52) U.S. Cl. 348/723; 348/730; 348/E05.127; 348/E05.093

(57) ABSTRACT

A communication module capable of reducing power consumption in an electronic unit is provided. A communication module includes: a communication section; and a control section determining handling of data received by the communication section from an external unit, based on one or both of a power state of a connected host unit and a type of the received data.

### CROSS-REFERENCE TO RELATED APPLICATION

The present application claims priority from Japanese Patent Application No. JP 2011-081615 filed in the Japanese Patent Office on Apr. 1, 2011, the entire content of which is incorporated herein by reference.

### BACKGROUND

The present technology relates to a communication module and a communication system transmitting and receiving data.

In recent years, various electronic units including mobile electronic units such as music players and digital cameras, televisions, and personal computers have been in widespread use. Various kinds of information are exchanged between these electronic units via wire or wireless communication. Therefore, for example, a user is allowed to listen, on a music player, to music data downloaded by a personal computer, or photographic data taken by a digital camera is allowed to be displayed on a television. Thus, communication between electronic units is essential for users to use these electronic units more easily.

In the electronic units, in terms of ecology and the like, a reduction in power consumption is desired, and various attempts have been made to reduce power consumption. For example, in Japanese Unexamined Patent Application Publication No. 2009-253528, there is proposed a content display system acquiring an electronic program guide (EPG) in real time via low-speed wireless communication when the main power of the content display system is off. Even if a user does not watch television, the content display system acquires a real-time electronic program guide with low power consumption via low- speed wireless communication consuming less power.

### SUMMARY

However, Japanese Unexamined Patent Application Publication No. 2009-253528 does not mention a reduction in power consumption in electronic units exchanging various kinds of information therebetween.

It is desirable to provide a communication module and a communication system capable of reducing power consumption in electronic units.

According to an embodiment of the technology, there is provided a first communication module mainly functioning as a receiver, the first communication module including: a communication section; and a control section. The control section determines handling of data received by the communication section from an external unit, based on one or both of a power state of a connected host unit and a type of the received data.

According to an embodiment of the technology, there is provided a second communication module mainly functioning as a receiver, the second communication module including: a storage section; a communication section; and a control section. The storage section holds transmission data received from a connected host unit. The communication section reads out the transmission data from the storage section to transmit the transmission data to an external unit. The control section determines, based on a type of the transmission data, whether the transmission data is retransmitted, when the communication section fails transmission of the transmission data.

According to an embodiment of the technology, there is provided a communication system including: a transmission module; and a reception module. The transmission module includes a storage section holding transmission data received from a connected transmission-side host unit, a transmission section reading out the transmission data from the storage section to transmit the transmission data to an external unit, and a transmission control section determining, based on a type of the transmission data, whether the transmission data is retransmitted, when the transmission section fails transmission of the transmission data. The reception module includes a reception section, and a control section determining handling of data received by the reception section from the transmission module, based on one or both of a power state of a connected reception-side host unit and a type of the received data.

In the first communication module and the communication system according to the embodiment of the technology, after data is received from an external unit, handing of the received data is determined. At this time, handling of the received data is determined, based on to one or both of a power state of the host unit and a type of the received data.

In the second communication module and the communication system according to the embodiment of the technology, transmission data is temporarily stored in the storage section, and after that, the transmission data is transmitted from the communication section. At this time, when transmission of the transmission data is failed, whether the transmission data is retransmitted is determined, based on a type of the transmission data.

In the first communication module and the communication system according to the embodiment of the technology, handling of the received data is determined, based on one or both of the power state of the host unit and the type of the received data; therefore, power consumption in the host unit is allowed to be reduced.

In the second communication module and the communication system according to the embodiment of the technology, when transmission of the transmission data is failed, whether the transmission data is retransmitted is determined, based on the type of the transmission data; therefore, power consumption in the host unit is allowed to be reduced.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a configuration diagram illustrating a configuration example of an electronic unit system according to an embodiment of the technology.

FIG. 2 is a block diagram illustrating a configuration example of a display illustrated in FIG. 1.

FIGS. 3A and 3B are explanatory diagrams illustrating a structural example of communication data relating to the electronic unit system illustrated in FIG. 1.

FIG. 4 is a block diagram illustrating a configuration example of a remote control according to a first embodiment.

FIG. 5 is a block diagram illustrating a configuration example of a weight scale according to the first embodiment.

FIG. 6 is a timing waveform chart illustrating an example of a communication operation in a normal mode of the electronic unit system according to the first embodiment.

FIG. 7 is a timing waveform chart illustrating an example of a communication operation in a standby mode of the electronic unit system according to the first embodiment.

FIG. 8 is a flowchart illustrating an operation example of a communication module of the display illustrated in FIG. 2.

FIG. 9 is a flowchart illustrating another operation example of the communication module of the display illustrated in FIG. 1.

FIG. 10 is a block diagram illustrating a configuration example of a weight scale according to a second embodiment.

FIG. 11 is a timing waveform chart illustrating an example of a communication operation of the weight scale illustrated in FIG. 10.

FIG. 12 is a flowchart illustrating an operation example of a communication module of the weight scale illustrated in FIG. 10.

### DETAILED DESCRIPTION OF THE PREFERRED EMBODIMENTS

Preferred embodiments of the technology will be described in detail below referring to the accompanying drawings. It is to be noted that description will be given in the following order.

### 1. First Embodiment

### 2. Second Embodiment

### 1. First Embodiment

### CONFIGURATION EXAMPLE

### WHOLE CONFIGURATION EXAMPLE

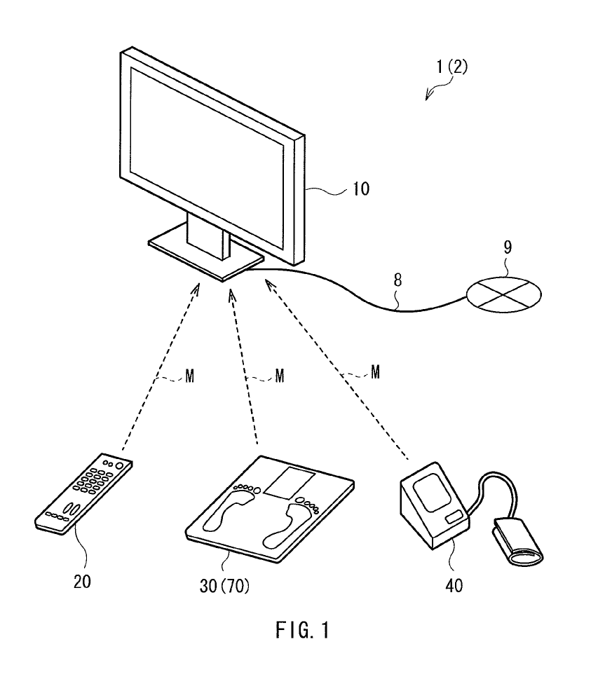

FIG. 1 illustrates a configuration example of an electronic unit system according to a first embodiment. It is to be noted that a communication module and a communication system according to an embodiment of the technology are embodied by this embodiment, and will be also described. An electronic unit system 1 includes a display 10, a remote control 20, a weight scale 30, and a sphygmomanometer 40.

The display 10 is, for example, a television, and displays received broadcast data. As will be described later, the display 10 has a function of receiving communication data D from the remote control 20, the weight scale 30, and the sphygmomanometer 40. Moreover, in this example, the display 10 is connected to the Internet 9 through a network cable 8.

The remote control 20 is a so-called remote controller, and has a function of transmitting, to the display 10, a control code (communication data D) for remotely controlling the display 10. The weight scale 30 is a weight measurement unit. In this example, the weight scale 30 has not only a function of measuring a weight, but also a function of transmitting, to the display 10, a measurement result (communication data D) to display the measurement result on a display screen of the display 10. The sphygmomanometer 40 is a blood pressure measurement unit. In this example, the sphygmomanometer 40 has not only a function of measuring a blood pressure, but also a function of transmitting, to the display 10, a measurement result (communication data D) to display the measurement result on the display screen of the display 10.

Communication between the display 10 and the remote control 20, the weight scale 30, and the sphygmomanometer 40 is carried out through a wireless communication mechanism M. As wireless communication, for example, communication based on ZigBee (registered trademark) RF4CE specifications is allowed to be used.

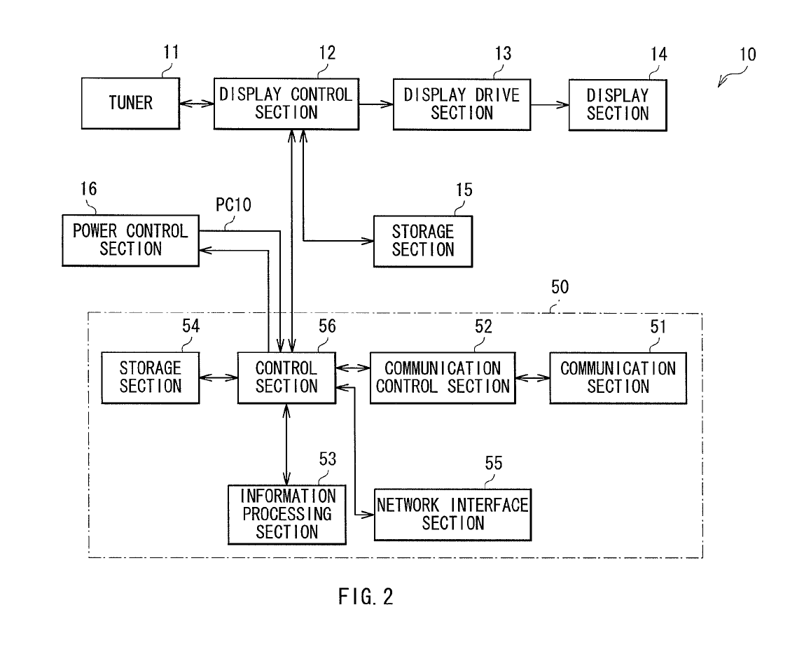

FIG. 2 illustrates a configuration example of the display 1. The display 10 includes a tuner 11, a display control section 12, a display drive section 13, a display section 14, a storage section 15, a power control section 16, a communication module 50. As will be described later, the display 10 has two operation modes, i.e., a normal mode and a standby mode. The display 10 displays, for example, a television program or the like in the normal mode, and the display 10 stops displaying the television program or the like by stopping power supply to a plurality of internal blocks in the standby mode. The communication module 50 is allowed to operate irrespective of the operation mode of the display 10.

The tuner 11 extracts broadcast data on a desired channel from broadcast data received by an antenna (not illustrated). The display control section 12 controls display on the display section 14. Moreover, in this example, the display control section 12 has a function of controlling the storage section 15 and an interfacing function to the communication module 50. The display drive section 13 drives the display section 14 in response to a signal supplied from the display control section 12. The display section 14 performs display on a display screen thereof. The storage section 15 holds data. More specifically, as will be described later, the storage section 15 holds the communication data D supplied from the communication module 50 to the display control section 12.

The power control section 16 controls power supply to the tuner 11, the display control section 12, the display drive section 13, the display section 14, and the storage section 15. More specifically, in the normal mode, the power control section 16 supplies power to these blocks, and in the standby mode, the power control section 16 stops supplying power to these blocks. Moreover, the power control section 16 is allowed to inform the communication module 50 of the operation mode of the display 10 with use of a power control signal PC10, and to control the operation mode of the display 10 in response to an instruction from the communication module 50.

The communication module 50 includes a communication section 51, a communication control section 52, an information processing section 53, a storage section 54, a network interface section 55, and a control section 56.

In this example, the communication section 51 exchanges the communication data D with the remote control 20, the weight scale 30, and the sphygmomanometer 40 through the wireless communication mechanism M. The communication control section 52 determines a subsequent process on the communication data D received by the communication section 51, based on the operation mode of the display 10 and the communication data D. Moreover, the communication control section 52 also has a function of controlling the communication section 51 to intermittently perform a reception operation when the display 10 is in the standby mode. The information processing section 53 performs information processing on the communication data D in response to a determination by the communication control section 52. The storage section 54 holds data. The network interface section 55 is an interface connecting to the Internet 9 through the network cable 8. The control section 56 controls the communication control section 52, the information processing section 53, the storage section 54, and the network interface section 55. Moreover, the control section 56 controls power supply to the information processing section 53 in response to the power control signal PC10 supplied from the power control section 16.

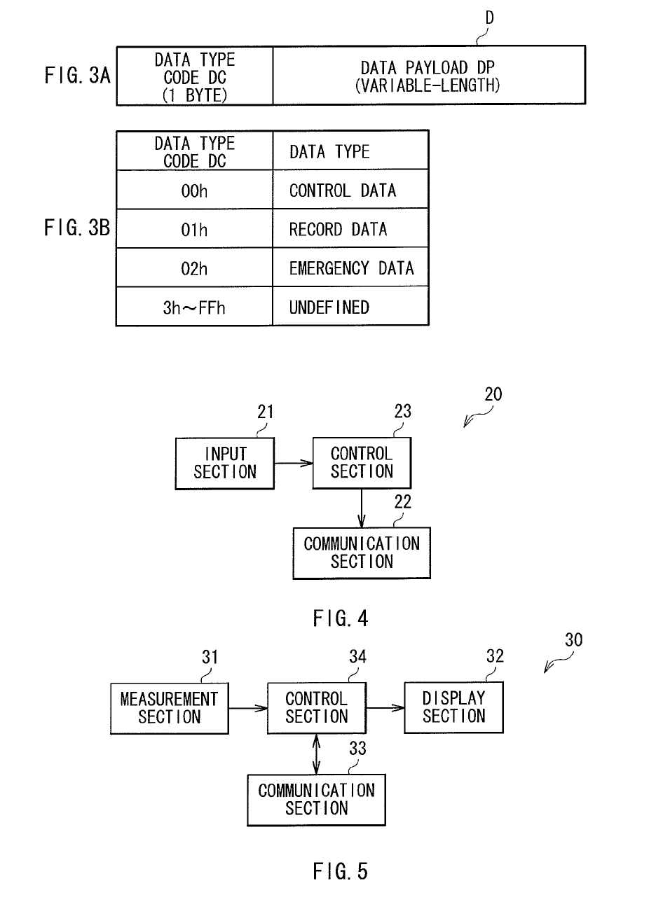

FIGS. 3A and 3B illustrate a structural example of the communication data D, and FIG. 3A illustrates a whole structure of the communication data D, and FIG. 3B illustrates functions of data type codes DC of the communication data D. The communication data D includes a variable-length data payload DP corresponding to information to be transmitted and received and a data type code DC corresponding to a header of the data payload DP. The data type code DC represents a data type of the data payload DP, and in this example, the data payload DP is a one-byte code. More specifically, for example, in the data type codes DC, “00h” represents that the data type is “control data”, “01h” represents that the data type is “record data”, and “02h” represents that the data type is “emergency data”.

The communication data D of which the data type is “control data” is, for example, data for controlling the display 10. The communication data D corresponds to, for example, a control code or the like, which is transmitted from the remote control 20, for turning on or off the power of the display 10 or for channel switching. As will be described later, when the communication section 51 receives the communication data D, the communication control section 52 determines, based on the data type code DC (“00h”) of the communication data D, that the communication data D is supposed to be transferred to the display 10. More specifically, for example, when the communication section 51 receives the communication data D providing an instruction to turn on or off the power of the display 10, the information processing section 53 provides the instruction to the power control section 16 in response to a determination by the communication control section 52. Moreover, for example, when the communication section 51 receives the communication data D providing an instruction to switch to another channel on the display 10, the information processing section 53 provides the instruction to the tuner 11 through the display control section 12 in response to a determination by the communication control section 52.

As will be described later, the communication data D of which the data type is “record data” is data which is supposed to be temporarily stored in the storage section 54 after being received by the communication section 51 in the case where the display 10 is in the standby mode. As will be described later, in the case where the display 10 is in the standby mode, when the communication section 51 receives the communication data D, the communication control section 52 determines, based on the data type code DC (“01h”) of the communication data D, that the communication data D is supposed to be stored in the storage section 54, and stores the communication data D in the storage section 54. Then, after that, when the display 10 is switched to the normal mode, the information processing section 53 transfers the communication data D from the storage section 54 to the storage section 15 through the control section 56 and the display control section 12. Then, the display control section 12 allows the display section 14 to perform display, based on the communication data D. The communication data D corresponds to, for example, a weight measurement result obtained by the weight scale 30, a blood pressure measurement result obtained by the sphygmomanometer 40.

As will be described later, the communication data D of which the data type is “emergency data” is data which is supposed to be transferred to a predetermined server connected to the Internet 9 immediately after being received by the communication section 51 in the case where the display 10 is in a standby state. As will be described later, when the communication section 51 receives the communication data D, the communication control section 52 determines, based on the data type code DC (“02h”) of the communication data D, that the communication data D is supposed to be immediately transferred to the predetermined server. Then, the information processing section 53 transfers the received data D to the predetermined server connected to the Internet 9 through the network interface section 55 in response to a determination by the communication control section 52. The communication data D corresponds to, for example, an abnormal blood pressure measurement result obtained by the sphygmomanometer 40, or the like. In this case, the communication data D is immediately transferred to, for example, a hospital.

FIG. 4 illustrates a configuration example of the remote control 20. The remote control 20 includes an input section 21, a communication section 22, and a control section 23. The input section 21 is an input interface allowing a user to input information. The communication section 22 transmits, to the display 10, a control code (communication data D) for controlling the display 10 in response to information supplied from the input section 21. The control section 23 controls the input section 21 and the communication section 22. Moreover, the control section 23 also has a function of generating the communication data D in a format illustrated in FIG. 3A.

FIG. 5 illustrates a configuration example of the weight scale 30. The weight scale 30 includes a measurement section 31, a display section 32, a communication section 33, and a control section 34. The measurement section 31 has a function of measuring a weight. The display section 32 displays a weight measurement result obtained by the measurement section 31. The communication section 33 transmits, to the display 10, the weight measurement result (communication data D) obtained by the measurement section 31. The control section 34 controls the measurement section 31, the display section 32, and the communication section 33. Moreover, the control section 34 also has a function of generating the communication data D in the format illustrated in FIG. 3A.

It is to be noted that the configuration of the sphygmomanometer 40 is similar to that of the weight scale 30 illustrated in FIG. 5. In other words, the measurement section 31 measures a blood pressure, and the display section 32 displays a blood pressure measurement result obtained by the measurement section 31. The communication section 33 transmits, to the display 10, the blood pressure measurement result (communication data D) obtained by the measurement section 31. The control section 34 controls the measurement section 31, the display section 32, and the communication section 33, and generates the communication data D in the format illustrated in FIG. 3A.

The communication module 50 corresponds to a specific example of a first communication module in the technology. The communication section 51 and the network interface 55 correspond to specific examples of “communication section” in the first communication module in the technology. The communication control section 52 corresponds to a specific example of “control section” in the first communication module in the technology.

### [Operations and Functions]

Next, operations and functions of the electronic unit system 1 according to the embodiment will be described below.

### (Summary of Entire Operation)

First, a summary of an entire operation of the electronic unit system 1 will be described below referring to FIGS. 1 to 5.

The tuner 11 extracts broadcast data on a desired channel from broadcast data received by the antenna. The display control section 12 controls display on the display section 14. The display drive section 13 drives the display section 14 in response to a signal supplied from the display control section 12. The display section 14 performs display on the display screen thereof. The storage section 15 holds the communication data D supplied from the communication module 50 through the display control section 12. The power control section 16 controls power supply to these blocks, and informs the communication module 50 of the operation mode of the display 10 with use of the power control signal PC10.

In the communication module 50, the communication section 51 receives the communication data D transmitted from the remote control 20, the weight scale 30, or the sphygmomanometer 40. The communication control section 52 determines a subsequent process on the communication data D received by the communication section 51, based on the operation mode of the display 10 and the communication data D. The information processing section 53 performs information processing on the communication data D in response to a determination by the communication control section 52. When the display 10 is in the standby mode, in the case where the data type of the communication data D is “record data”, the storage section 54 holds the communication data D. In the case where the data type of the communication data D is “emergency data”, the network interface section 55 transfers the communication data D to a predetermined server connected to the Internet 9. The control section 56 controls these blocks.

### (Communication Operation)

Next, a communication operation in the electronic unit system 1 will be described in the case where the weight scale 30 (the communication section 33) transmits the communication data D to the display 10 (the communication section 51) as an example. First, a communication operation in the case where the display 10 is in the normal mode will be described below, and then a communication operation in the case where the display 10 is in the standby mode will be described below.

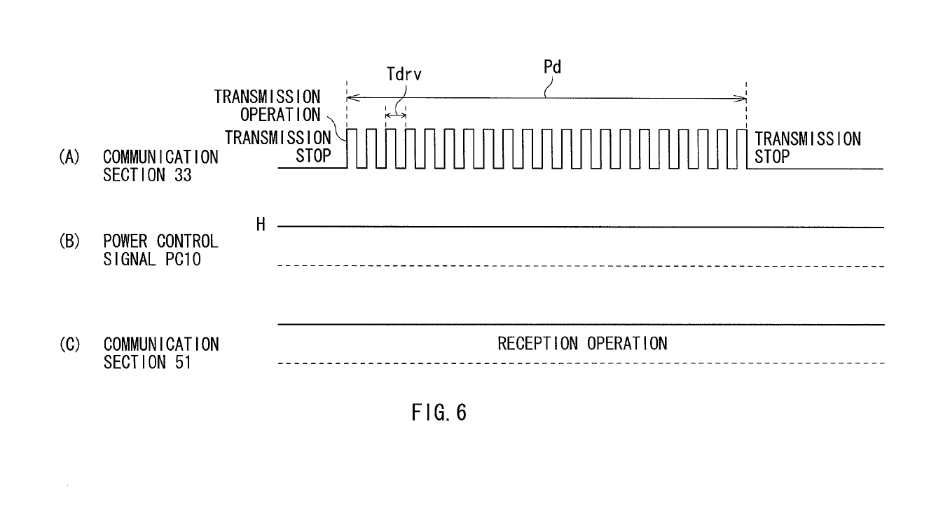

FIG. 6 illustrates the communication operation in the case where the display 10 is in the normal mode, and a part (A) illustrates a state of a transmission operation in the communication section 33, a part (B) illustrates a waveform of the power control signal PC10 in the display 10, and a part (C) illustrates a state of a reception operation in the communication section 51. In this case, a high voltage level of the power control signal PC10 represents that the display 10 is in the normal mode, and a low voltage level of the power control signal PC10 represents that the display 10 is in the standby mode.

The weight scale 30 transmits, to the display 10, a measurement result (communication data D), for example, just after a user measures his weight or when the user intentionally provides an instruction to transmit the measurement result. At this time, as illustrated in the part (A) in FIG. 6, the communication section 33 of the weight scale 30 performs a transmission operation in a predetermined period (a transmission period Pd). In the transmission period Pd, the communication section 33 repeats an operation of transmitting the communication data D at every transmission operation cycle Tdrv. The duration of the transmission period Pd is allowed to be set to, for example, 1 [sec]. In this case, the duration of the transmission operation cycle Tdry is allowed to be set to, for example, 1 [msec].

In the display 10, the power control section 16 supplies, to the communication module 50, the power control signal PC10 with a high voltage level (refer to the part (B) in FIG. 6). The control section 56 of the communication module 50 ascertains, based on the power control signal PC10, that the display 10 is in the normal mode, and informs the communication control section 52 as such. Then, as illustrated in the part (C) in FIG. 6, the communication control section 52 controls the communication section 51 to be consistently in a reception operation state. Therefore, when the communication section 33 of the weight scale 30 starts transmission of the communication data D, the communication section 51 is allowed to immediately receive the communication data D.

It is to be noted that in this example, the communication section 33 of the weight scale 30 repeatedly performs a transmission operation in the transmission period Pd; however, the technology is not limited thereto, and the communication section 33 of the weight scale 30 may stop the transmission operation after completing the transmission of the communication data D to the communication section 51 of the display 10.

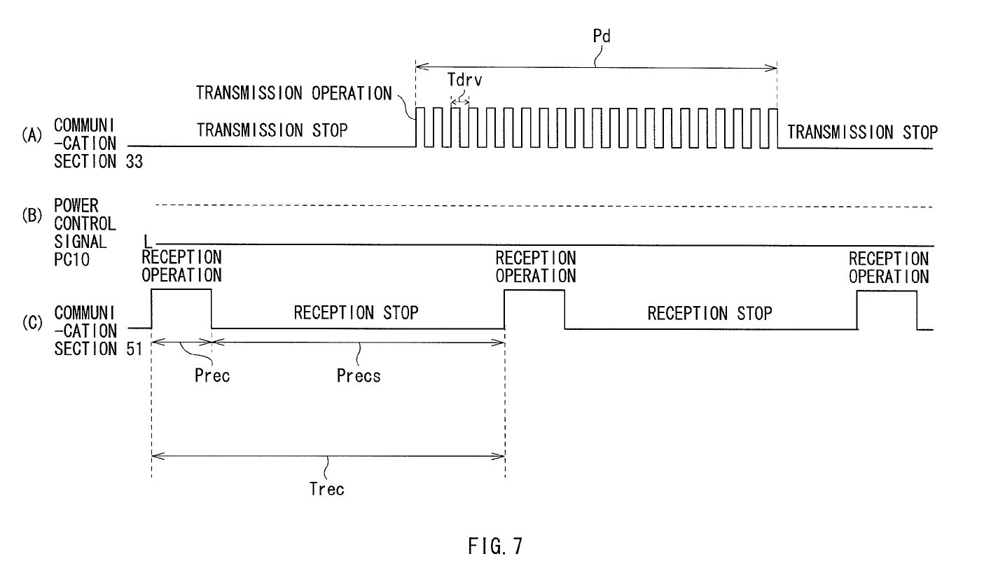

FIG. 7 illustrates a communication operation in the case where the display 10 is in the standby mode, and a part (A) illustrates a state of a transmission operation in the communication section 33, a part (B) illustrates a waveform of the power control signal PC10 in the display 10, and a part (C) illustrates a state of a reception operation in the communication section 51.

In the weight scale 30, as illustrated in the part (A) in FIG. 7, as in the case of FIG. 6, the communication section 33 repeatedly performs a transmission operation in the transmission period Pd.

On the other hand, in the display 10, the power control section 16 supplies, to the communication module 50, the power control signal PC10 with a low voltage level (refer to the part (B) in FIG. 7). The control section 56 of the communication module 50 ascertains, based on the power control signal PC10, that the display 10 is in the standby mode, and informs the communication control section 52 as such. Then, as illustrated in the part (C) in FIG. 7, the communication control section 52 controls the communication section 51 to intermittently perform a reception operation. More specifically, the communication section 51 repeatedly performs a reception operation in each reception operation cycle Trec. Then, each cycle includes a period (a reception operation period Prec) in which a reception operation is performed and a period (a reception stop period Precs) in which the reception operation is stopped. In other words, the communication section 51 consumes power only in the reception operation period Prec, and does not consume power in the reception stop period Precs. In this case, the duration of the reception operation cycle Trec is allowed to set to, for example, 1 [sec]. In this case, the duration of the period of a reception operation (reception operation period Prec) in each cycle is allowed to set to, for example, 16.8 [msec].

In this example, in the electronic unit system 1, the duration of the transmission period Pd is determined to become equal to the duration of the reception operation cycle Trec; therefore, as illustrated in FIG. 7, even in the case where the communication section 51 of the display 10 performs an intermittent operation, a period in which the transmission period Pd and the reception operation period Prec of the communication section 33 overlap each other is produced. Therefore, in the electronic unit system 1, even in the case where the display 10 is in a standby state, communication is allowed to be carried out. It is to be noted that in this example, the duration of the transmission period Pd is equal to the duration of the reception operation cycle Trec; however, the duration of the transmission period Pd is not limited thereto, and may be determined to become equal to or longer than the duration of the reception operation cycle Trec.

Thus, in the electronic unit system 1, in the case where the display 10 is in the standby mode, the communication section 51 intermittently performs a reception operation; therefore, power consumption is allowed to be reduced. More specifically, for example, in the case where a consumption current of the communication section 51 in the reception operation is 30 [mA], an average consumption current of the communication section 51 is allowed to be reduced to approximately 0.5 [mA] (=30 [mA]×16.8 [msec]/1 [sec]) by such an intermittent operation.

Moreover, in the communication module 50 of the display 10, in the case where the display 10 is in the standby mode, the control section 56 controls the power of the information processing section 53 to be turned off. Thus, power consumption is allowed to be reduced.

### (Specific Operation of Communication Module 50 in Display 10)

Next, a specific operation in the case where the communication module 50 in the display 10 receives the communication data D will be described below.

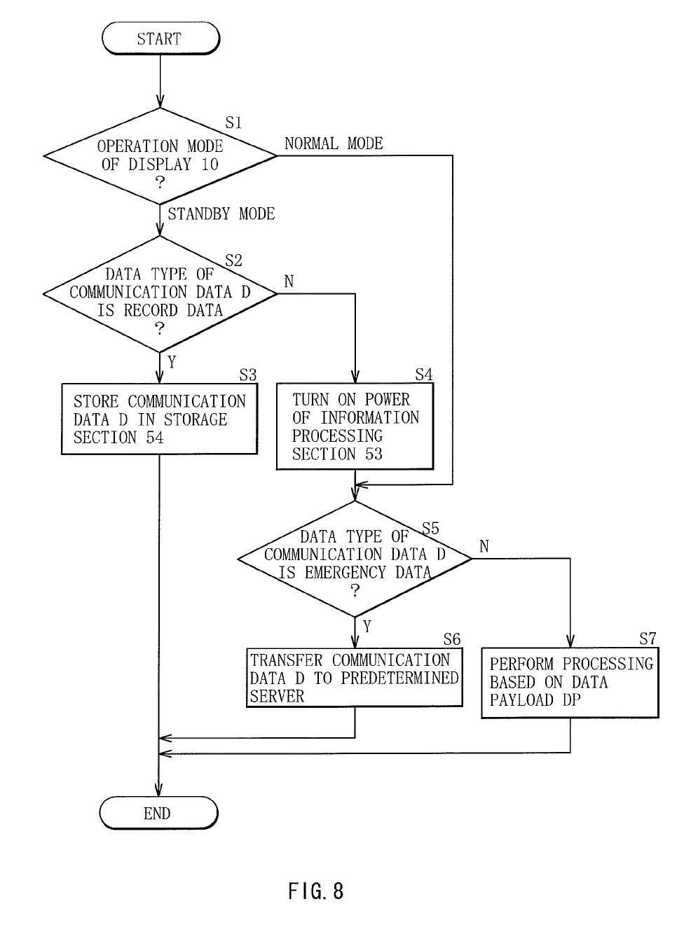

FIG. 8 illustrates an operation example of the communication module 50. In the communication module 50, a process on the received communication data D is determined based on the data type code DC (data type) of the communication data D. The process will be specifically described below.

First, the control section 56 confirms the operation mode of the display 10 (step S1). More specifically, the control section 56 confirms, based on the power control signal PC10 supplied from the power control section 16, whether the display 10 is in the normal mode or the standby mode. Then, the control section 56 informs the communication control section 52 of the operation mode. In the case of the standby mode, the process proceeds to step S2, and in the case of the normal mode, the process proceeds to step S5.

In the step S1, in the case where the display 10 is in the standby mode, the communication control section 52 confirms whether the data type of the received communication data D is “record data”. (step S2). More specifically, the communication control section 52 confirms, based on the data type code DC of the communication data D received by the communication section 51, whether the data type of the communication data D is “record data”. When the data type is “record data”, the process proceeds to step S3, and when the data type is not “record data”, the process proceeds to step S4.

In the step S2, in the case where the data type of the received communication data D is “record data”, the communication control section 52 allows the storage section 54 to hold the communication data D (step S3). Then, the flow of the operation is completed.

In the step S2, in the case where the data type of the received communication data D is not “record data”, the control section 56 turns on the power of the information processing section 53 (step S4).

Next, the communication control section 52 confirms whether the data type of the received communication data D is “emergency data” (step S5). More specifically, the communication control section 52 confirms, based on the data type code DC of the communication data D received by the communication section 51, whether the data type of the communication data D is “emergency data”. When the data type is “emergency data”, the process proceeds to step S6, and when the data type is not “emergency data”, the process proceeds to step S7.

In the step S5, in the case where the data type of the received communication data D is “emergency data”, the information processing section 53 transfers the communication data D to a predetermined server connected to the Internet 9 (step S6). More specifically, the information processing section 53 transmits the communication data D received by the communication section 51 to the predetermined server connected to the Internet 9 through the network interface section 55 in response to an instruction from the communication control section 52.

In the step S6, in the case where the data type of the received communication data D is not “emergency data”, the information processing section 53 performs information processing, based on information of the data payload DP (step S7). More specifically, the information processing section 53 performs, in response to an instruction from the communication control section 52, information processing, based on information of the data payload DP of the communication data D received by the communication section 51.

In the step S7, the communication module 50 undergoes the above-described flow of the operation; therefore, in the case where the display 10 is in the normal mode (in the case where the operation proceeds in order of the steps S1, S5 and S7), the data type of the communication data D is “record data” or “control data”. Therefore, in the case where the communication data D is, for example, a weight measurement result transmitted from the weight scale 30 (the data type is “record data”), the information processing section 53 transmits the communication data D to the storage section 15 through the display control section 12 without storing the communication data D in the storage section 54. Then, the display control section 12 controls the display section 14 to perform display, based on to the communication data D stored in the storage section 15. Moreover, in the case where the communication data D is, for example, a control code for channel switching transmitted from the remote control (the data type is “control data”), the information processing section 53 transmits the communication data D to the display control section 12. Then, the display control section 12 controls the tuner 11 to perform channel switching.

Moreover, in the case where the display 10 is in the standby mode (the operation proceeds in order of the steps S1, S2, S4, S5, and S7), the data type of the communication data D is “control data”. Therefore, in the case where the communication data D is, for example, a control code, which is transmitted from the remote control 20, for turning on the power of the display 10, the information processing section 53 transmits the communication data D to the power control section 16. Then, the power control section 16 supplies power to each block of the display 10 to switch the display 10 from the standby mode to the normal mode. Moreover, in the case where the communication data D is, for example, a control code for channel switching of the display 10, since the display 10 is in the standby mode, the information processing section 53 determines that the communication data D is invalid, and discards the communication data D.

Thus, the flow of the operation is completed.

Thus, the communication module 50 of the display 10 determines a subsequent process on the received communication data D, based on the communication data D.

More specifically, as described above, in the case where the display 10 is in the standby mode, when the data type of the received communication data D is “record data”, the communication module 50 determines that it is not necessary to immediately take any action, and allows the storage section 54 to temporarily hold the communication data D as illustrated in the step S3 in FIG. 8 to perform a process when necessary. In other words, in this case, the display 10 is kept in the standby mode.

Moreover, in the case where the received communication data D is “emergency data”, the communication module 50 determines that it is necessary to immediately take an action, and as illustrated in the step S6 in FIG. 8, the communication module 50 transmits the communication data D to the predetermined server.

Further, in the case where the received communication data D is “control data”, as illustrated in the step S7 in FIG. 8, the communication module 50 performs information processing, based on information of the data payload DP. More specifically, in the case where the display is in the standby mode, when the received communication data D is a control code for turning on the power of the display 10, the communication module 50 determines that it is necessary to immediately take an action, and transmits the control code to the power control section 16. Moreover, in the case where the display 10 is in the standby mode, when the received communication data D is a control code for channel switching of the display 10, for example, the communication module 50 determines that the communication data D is invalid, and discards the communication data D.

Thus, the communication module 50 determines a subsequent process on the received communication data D, based on the communication data D; therefore, the communication module 50 is allowed to control power supply to each block of the display 10, based on the communication data D, and power consumption is allowed to be reduced accordingly.

As described above, in the case where the display 10 is in the standby mode, when the data type of the received communication data D is “record data”, as illustrated in the step S3 in FIG. 8, the communication data D is stored in the storage section 54. At this time, the display 10 is kept in the standby mode. When a user turns on the power of the display 10, the communication data D stored in the storage section 54 is transferred to the storage section 15 through the control section 56 and the display control section 12. Such an operation will be described below.

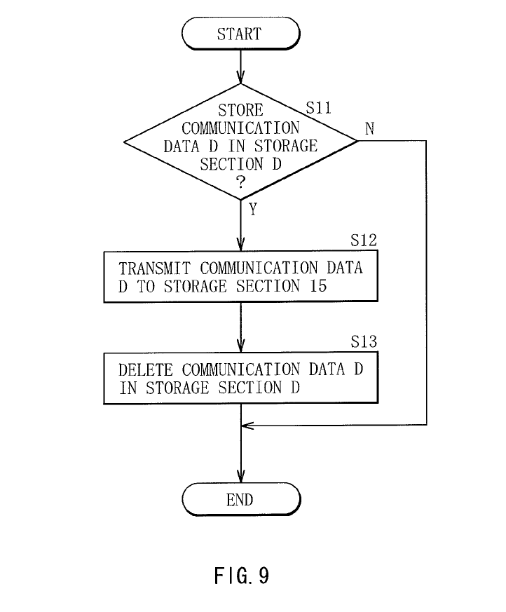

FIG. 9 illustrates an operation example of the communication module 50 when the user turns on the power of the display 10.

First, the information processing section 53 confirms whether the communication data D is stored in the storage section 54 (step S11). In the case where the communication data D is stored in the storage section 54, the operation proceeds to step S12, and in the case where the communication data D is not stored in the storage section 54, the flow of the operation is completed.

In the step S11, in the case where the communication data D is stored in the storage section 54, the information processing section 53 transmits the communication data D stored in the storage section 54 to the storage section 15 through the control section 56 and the display control section (step S12). Then, the display control section 12 controls the display section 14 to perform display, based on the communication data D (for example, a weight measurement result transmitted from the weight scale 30) stored in the storage section 15.

Next, the information processing section 53 deletes the communication data D stored in the storage section 54 (step S13).

Thus, the flow of the operation is completed.

Thus, in the case where the display 10 is in the standby mode, when the data type of the received communication data D is “record data”, the communication module 50 of the display 10 allows the storage section 54 to temporarily hold the communication data D (step S3 in FIG. 8), and after that, when the user turns on the power of the display 10 , the communication module 50 of the display 10 transmits the communication data D to the storage section 15 (step S12 in FIG. 9). In other words, it is not necessary to take any action on the communication data D; therefore, when the communication module 50 receives the communication data D, the communication module 50 allows the storage section 54 to temporarily hold the communication data D without immediately switching the display 10 from the standby mode to the normal mode, and after that, when the display 10 is switched to the normal mode through turning on the power of the display 10 by the user, the communication module 50 transmits the communication data D to the storage section 15.

Thus, the communication module 50 includes the storage section 54, and in the case where the display 10 is in the standby mode, when the data type of the communication data D is “record data”, the communication data D is temporarily stored in the storage section 54 to be processed when necessary; therefore, the display 10 is not switched to the normal mode upon reception of the communication data D, and power consumption is allowed to be reduced accordingly.

### [Effects]

Thus, in the embodiment, the display is allowed to receive data even in the standby state; therefore, it is not necessary for the display to be in a normal operation state for data reception, and power consumption in the display is allowed to be reduced accordingly.

Moreover, in the embodiment, in the case where the display is in the standby mode, the communication section of the display intermittently performs a reception operation: therefore, power consumption in the communication section is allowed to be reduced.

Further, in the embodiment, a subsequent process on received communication data is determined, based on the communication data; therefore, power supply to each block of the display is allowed to be controlled, based on the communication data, and power consumption is allowed to be reduced.

Moreover, in the embodiment, the communication module includes the storage section, and in the case where the display is in the standby mode, when the data type of the received communication data is “record data”, the communication data is temporarily stored in the storage section to perform processing on the communication data as necessary; therefore, it is not necessary for the display to be switched to the normal mode upon data reception, and power consumption is allowed to be reduced.

### [Modification 1-1]

In the above-described embodiment, the electronic unit system 1 includes the remote control 20, the weight scale 30, and the sphygmomanometer 40; however, the electronic unit system 1 is not limited thereto, and the electronic unit system 1 may include any electronic unit, such as a mobile information terminal, exchanging the communication data D with the display 10.

[Modification 1-2]

In the above-described embodiment, in the case where data type of the received communication data D is “emergency data”, the display 10 transfers the communication data D to the predetermined server connected to the Internet 9; however, the technology is not limited thereto. For example, in the case where the communication data D is an abnormal blood pressure measurement result obtained by the sphygmomanometer 40, the display 10 may transmit the result to a mail address of a family doctor, or may call the family doctor to inform him that the result is abnormal, when the display 10 is connected to a telephone network.

[Modification 1-3]

In the above-described embodiment, in the case where the communication data D received when the display 10 is in the standby mode is a control code for channel switching of the display 10, the communication data D is discarded; however, the technology is not limited thereto, and, for example, the power control section 16 may be controlled to turn on the power of the display 10, and the tuner 11 may be controlled to perform channel switching on the display 10, based on the communication data D.

### 2. Second Embodiment

Next, an electronic unit system 2 according to a second embodiment will be described below. In the embodiment, a remote control, a weight scale, a sphygmomanometer, or the like transmitting the communication data D includes a communication module including a storage section. In the electronic unit system 2 according to the second embodiment, like components are denoted by like numerals as of the electronic unit system 1 according to the first embodiment and will not be further described. It is to be noted that as an example of an electronic unit which includes a communication module including a storage section, a weight scale will be described below.

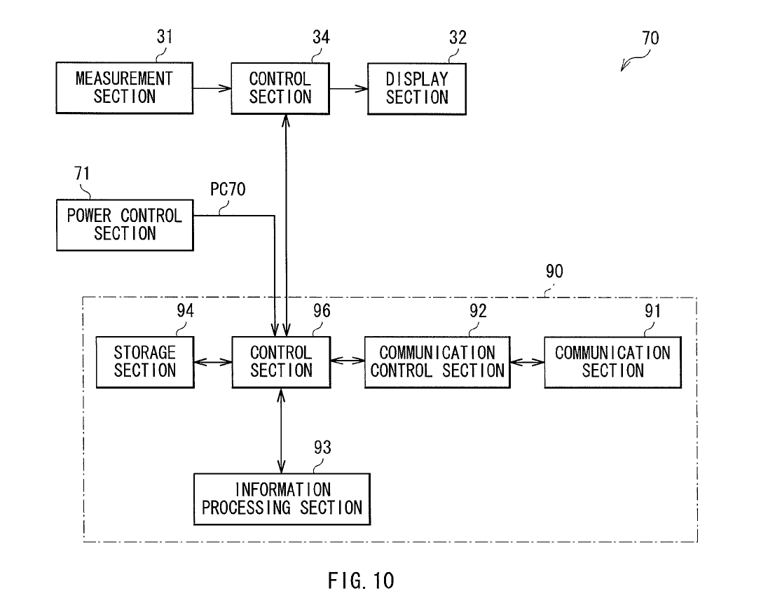

FIG. 10 illustrates a configuration example of a weight scale 70 in the electronic unit system 2 according to the embodiment. The weight scale 70 includes a power control section 71 and a communication module 90. The weight scale 70 has two operation modes, i.e., a normal mode and a standby mode. In the normal mode, the weight scale 70 measures, for example, a weight and displays the result, and in the standby mode, the weight scale 70 stops an operation by stopping power supply to a plurality of internal blocks. The communication module 90 is operable irrespective of the operation mode of the weight scale 70.

The power control section 71 controls power supply to the measurement section 31, the display section 32, and the control section 34. More specifically, the power control section 71 supplies power to these blocks in the normal mode, and stops power supply to these blocks in the standby mode. Moreover, the power control section 71 has a function of informing the communication module 90 of the operation mode of the weight scale 70 with use of a power control signal PC70.

The communication module 90 includes a communication section 91, a storage section 94, an information processing section 93, a communication control section 92, and a control section 96.

In this example, the communication section 91 exchanges the communication data D with the display 10 through the wireless communication mechanism M. The storage section 94 holds the communication data D which is supposed to be transmitted. The information processing section 93 performs control to store, in the storage section 94, the communication data D supplied from the control section 34 to the control section 96, and instructs the communication control section 92 to transmit the communication data D to the display 10. The communication control section 92 controls a transmission operation of the communication section 91. Moreover, as will be described later, when the data type of the communication data D which is supposed to be transmitted is “record data”, and communication between the communication section 91 and the display 10 is failed, the communication control section 92 transmits the communication data D at predetermined intervals until the communication succeeds. The control section 96 controls these blocks.

Herein, the communication module 90 corresponds to a specific example of a second communication module in the technology. The communication control section 92 corresponds to a specific example of “control section” in the second communication module in the technology.

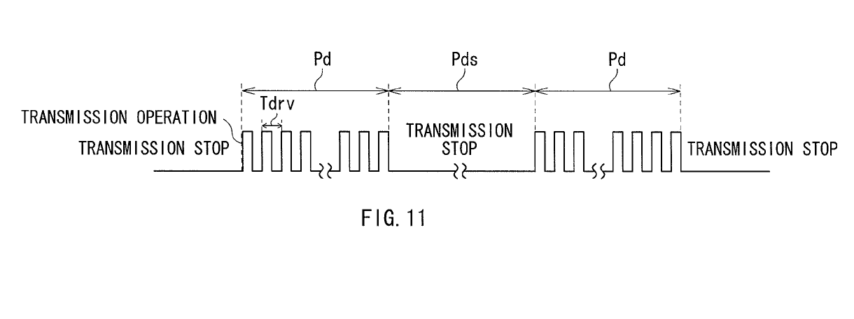

FIG. 11 illustrates a transmission operation example of the communication section 91 in the case where communication is failed. For example, in the case where communication is carried out between a mobile information terminal and the display 10, when the mobile information terminal and the display are located at a distance from each other, wireless communication may be failed. Moreover, in the case where a frequency band of wireless communication is equal to that of a microwave oven, or the like, when the microwave oven is activated, the wireless communication may be failed. In the electronic unit system 2, in such cases, the communication section 91 repeats the transmission operation until communication succeeds. More specifically, as illustrated in FIG. 11, the communication section 91 repeatedly transmits the communication data D in a transmission period Pd as in the case of the communication section 33 according to the first embodiment (refer to the part (A) in FIG. 6). Then, in the case where communication does not succeed in the transmission period Pd, another transmission period Pd is provided after a predetermined interval (a transmission stop period Pds), and the communication data D is transmitted. The communication section 91 repeats this operation until communication succeeds. The duration of the transmission stop period Pds is allowed to set to, for example, 1 [min].

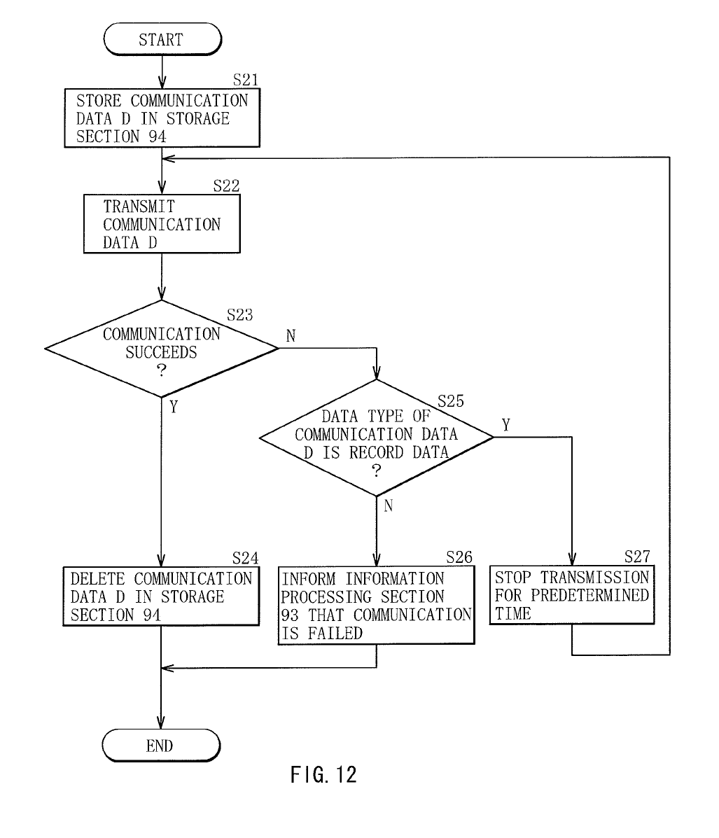

FIG. 12 illustrates an operation example of the communication module 90. In the communication module 90, when the data type of the communication data D stored in the storage section 94 is “record data”, the communication data D is repeatedly transmitted until communication succeeds. The operation example will be described in detail below.

First, the information processing section 93 allows the storage section 94 to hold the communication data D (step S21). More specifically, the control section 96 receives, from the control section 34, the communication data D which is supposed to be transmitted, and the information processing section 93 allows the storage section 94 to hold the communication data D.

Next, the communication section 91 transmits the communication data D to the display 10 (step S22). More specifically, first, the information processing section 93 instructs the communication control section 92 to perform transmission. Then, the communication control section 92 controls the communication section 91 in response to an instruction from the information processing section 93, and the communication section 91 transmits the communication data D stored in the storage section 94 to the display 10.

Next, the communication control section 92 confirms whether communication succeeds (step S23). When communication succeeds, the operation proceeds to step S24, and when communication is failed, the operation proceeds to step S25.

In the step S23, in the case where communication succeeds, the communication control section 92 deletes the communication data D stored in the storage section 94 (step S24). Then, the flow of the operation is completed.

Moreover, in the step S23, when communication is failed, the communication control section 92 confirms whether the data type of the communication data D is “record data” (step S25). More specifically, the communication control section 92 confirms, based on the data type code DC of the communication data D, whether the data type of the communication data D is “record data”. When the data type is not “record data”, the operation proceeds to step S26, and when the data type is “record data”, the operation proceeds to step S27.

In the step S25, in the case where the data type of the communication data D is not “record data”, the communication control section 92 informs the information processing section 93 that communication is failed (step S26). Then, the flow of the operation is completed.

Moreover, in the step S25, when the data type of the communication data D is “record data”, more specifically, the communication control section 92 controls the communication section 91 to stop transmission for a predetermined time (the transmission stop period PS) (step S27). Then, after a lapse of the predetermined time, the operation returns to the step S22. Then, the communication data D is transmitted until communication succeeds.

Thus, the flow of the operation is completed.

Thus, when communication of the communication data D is failed, the communication module 90 of the weight scale 70 determines, based on the communication data D, whether the communication data D is retransmitted.

More specifically, as described above, when the data type of the communication data D is “record data”, the communication module 90 determines that the communication data D is essential data which is necessary to be reliably transmitted to the display 10, and repeatedly transmits the communication data D until transmission succeeds.

Moreover, when the data type of the communication data D is not “record data” (a control code or the like for remotely controlling the display 10), the communication module 90 determines that the communication data D is not essential, and does not retransmit the communication data D, and informs the information processing section 93 that communication is failed. Therefore, after that, when the user turns on the power of the weight scale 70, the user is allowed to be informed that transmission is failed. At this time, the storage section 94 still holds the communication data D; therefore, the communication data D is allowed to be retransmitted in response to, for example, an instruction by the user.

Thus, in the case where the transmission of the communication data D is failed, the communication module 90 determines, based on the communication data D, whether the communication data D is retransmitted; therefore, transmission of the communication data D which is less necessary is not repeated, and power consumption in the communication module 90 is allowed to be reduced.

As described above, the communication module 90 is operable irrespective of the operation mode of the weight scale 70. As the communication module 90 includes the storage section 94, the communication module 90 is allowed to transmit the communication data D irrespective of the operation mode of the weight scale 70. More specifically, in FIG. 12, after the control section 34 transmits, to the communication module 90, the communication data D which is supposed to be transmitted, and the communication data D is stored in the storage section (after the step S21), the weight scale 70 may be switched to a standby state. Even in this case, the communication module 90 is allowed to transmit the communication data D stored in the storage section 94 to the display 10. In other words, it is not necessary for the weight scale 70 to be switched to a normal state to transmit the communication data D; therefore, when the weight scale 70 is switched to a standby state, power consumption is allowed to be reduced.

As described above, in the embodiment, as the communication module includes the storage section, the weight scale is allowed to be in the standby state when communication data is transmitted; therefore, power consumption is allowed to be reduced.

Moreover, in the embodiment, in the case where communication of the communication data is failed, whether the communication data is retransmitted is determined, based on the communication data; therefore, the communication data which is less necessary to be transmitted is not retransmitted, and power consumption in the communication module is allowed to be reduced accordingly.

Other effects are similar to those in the first embodiment.

### [Modification 2]

As in the case of the modification of the first embodiment, the electronic unit system 2 may include any electronic unit, such as a mobile information terminal, exchanging the communication data D with the display 10.

Although the present technology is described referring to the embodiments and modifications, the technology is not limited thereto, and may be variously modified.

For example, in the above-described embodiments, the electronic unit system includes the display 10; however, the electronic unit system is not limited thereto, and instead of the display 10, the electronic unit system may include any other electronic unit, for example, a personal computer.

For example, in the above-described embodiments, the electronic unit system allows the display and the weight scale or the sphygmomanometer to exchange the communication data D therebetween, and allows the display to display the communication data D transmitted from the weight scale or the sphygmomanometer; however, the technology is not limited thereto, and communication data may be exchanged, for example, between a printer and a personal computer, and communication data transmitted from the personal computer may be printed on the printer. In this case, for example, in the case where “priority data” is prepared as a data type of the communication data, and a plurality of pieces of communication data is stored in a printer queue, communication data of which the data type is “priority data” may be preferentially printed.

Moreover, for example, in the above-described embodiments, the communication module 50 is embedded in the display 10; however, the technology is not limited thereto, and the communication module 50 may be externally attached to the display 10.

Further, for example, in the above-described embodiments, the remote control, the weight scale, and the sphygmomanometer transmit the communication data D, and the display 10 receives the communication data D; however, the technology is not limited thereto. For example, the display 10 may have a function of transmitting the communication data D in addition to a function of receiving the communication data D. In this case, for example, the display 10 may have a transmission function similar to that of the communication module 90 according to the second embodiment. Moreover, for example, the remote control, the weight scale, and the sphygmomanometer may have a function of receiving the communication data D in addition to a function of transmitting the communication data D. In this case, the remote control, the weight scale, and the sphygmomanometer may have a reception function similar to that of the communication module 50.

For example, in the above-described embodiments, there are three data types of the communication data D, i.e., control data, record data, and emergency data; however, the data types are not limited thereto, and the data type may include any data type used for the communication control section 52 of the display 10 to determine, based on the data type, a process on the communication data D after reception of the communication data D.

For example, in the above-described embodiments, the remote control, the weight scale, and the sphygmomanometer exchanges the communication data D with the display 10 through the wireless communication mechanism M; however, the technology is not limited thereto, and alternatively, a wire communication mechanism may be used.

It is to be noted that the technology is allowed to have the following configurations.

(1) A communication module including:

a communication section; and

a control section determining handling of data received by the communication section from an external unit, based on one or both of a power state of a connected host unit and a type of the received data.

(2) The communication module according to (1) further including a storage section, in which

the control section performs control to store the received data in the storage section, when power of the host unit is off.

(3) The communication module according to (2), in which

the control section performs control to store the received data in the storage section, when the received data is non-emergency data.

(4) The communication module according to (2) or (3), in which

the control section reads out the received data from the storage section to transmit the received data to the host unit, when power of the host unit is turned from off to on.

(5) The communication module according to any one of (1) to (4), in which

the control section performs control to transmit one or more control commands to the host unit, when the received data is command data to control the host unit.

(6) The communication module according to (5), in which

the control section performs control to transmit, to the host unit, one or more control commands including a start command to activate the host unit, when power of the host unit is off.

(7) The communication module according to any one of (1) to (6), in which

the control section performs control to transfer the received data to an external unit through the communication section, when the received data is emergency data.

(8) The communication module according to any one of (1) to (7), in which

the control section is switched to a power-saving mode, when power of the host unit is turned off.

(9) The communication module according to (8), in which

the control section allows the communication section to intermittently operate in the power-saving mode.

(10) The communication module according to (8) or (9), in which

the control section is switched to a normal mode, when the host unit is turned on again.

(11) The communication module according to any one of (1) to (10), in which

the received data includes a type code representing a type thereof.

(12) The communication module according to any one of (1) to (11), in which

the control section further performs control to store, in the storage section, transmission data received from the host unit and to read out the transmission data from the storage section to transmit the transmission data to an external unit through the communication section, and

the control section determines, based on a type of the transmission data, whether the transmission data is retransmitted, when the communication section fails transmission of the transmission data.

(13) A communication module including:

a storage section holding transmission data received from a connected host unit;

a communication section reading out the transmission data from the storage section to transmit the transmission data to an external unit;

a control section determining, based on a type of the transmission data, whether the transmission data is retransmitted, when the communication section fails transmission of the transmission data.

(14) A communication system including:

a transmission module; and

a reception module receiving data transmitted from the transmission module,

in which the transmission module includes

a storage section holding transmission data received from a connected transmission-side host unit,

a transmission section reading out the transmission data from the storage section to transmit the transmission data to an external unit, and

a transmission control section determining, based on a type of the transmission data, whether the transmission data is retransmitted, when the transmission section fails transmission of the transmission data, and

the reception module includes

a reception section, and

a control section determining handling of data received by the reception section from the transmission module, based on one or both of a power state of a connected reception-side host unit and a type of the received data.

It should be understood by those skilled in the art that various modifications, combinations, sub-combinations, and alterations may occur depending on design requirements and other factors insofar as they are within the scope of the appended claims or the equivalents thereof.

What is claimed is:

1. A communication module comprising:
a communication section; and
a control section determining handling of data received by the communication section from an external unit, based on one or both of a power state of a connected host unit and a type of the received data.

2. The communication module according to claim 1 further comprising a storage section, wherein
the control section performs control to store the received data in the storage section, when power of the host unit is off.

3. The communication module according to claim 2, wherein
the control section performs control to store the received data in the storage section, when the received data is non-emergency data.

4. The communication module according to claim 2, wherein
the control section reads out the received data from the storage section to transmit the received data to the host unit, when power of the host unit is turned from off to on.

5. The communication module according to claim 1, wherein
the control section performs control to transmit one or more control commands to the host unit, when the received data is command data to control the host unit.

6. The communication module according to claim 5, wherein
the control section performs control to transmit, to the host unit, one or more control commands including a start command to activate the host unit, when power of the host unit is off.

7. The communication module according to claim 1, wherein
the control section performs control to transfer the received data to an external unit through the communication section, when the received data is emergency data.

8. The communication module according to claim 1, wherein
the control section is switched to a power-saving mode, when power of the host unit is turned off.

9. The communication module according to claim 8, wherein
the control section allows the communication section to intermittently operate in the power-saving mode.

10. The communication module according to claim 8, wherein
the control section is switched to a normal mode, when the host unit is turned on again.

11. The communication module according to claim 1, wherein
the received data includes a type code representing a type thereof.

12. The communication module according to claim 1, wherein
the control section further performs control to store, in the storage section, transmission data received from the host unit and to read out the transmission data from the storage section to transmit the transmission data to an external unit through the communication section, and
the control section determines, based on a type of the transmission data, whether the transmission data is retransmitted, when the communication section fails transmission of the transmission data.

13. A communication module comprising:
a storage section holding transmission data received from a connected host unit;
a communication section reading out the transmission data from the storage section to transmit the transmission data to an external unit;
a control section determining, based on a type of the transmission data, whether the transmission data is retransmitted, when the communication section fails transmission of the transmission data.

14. A communication system comprising:
a transmission module; and
a reception module receiving data transmitted from the transmission module,
wherein the transmission module includes
a storage section holding transmission data received from a connected transmission-side host unit,
a transmission section reading out the transmission data from the storage section to transmit the transmission data to an external unit, and
a transmission control section determining, based on a type of the transmission data, whether the transmission data is retransmitted, when the transmission section fails transmission of the transmission data, and
the reception module includes
a reception section, and
a control section determining handling of data received by the reception section from the transmission module, based on one or both of a power state of a connected reception-side host unit and a type of the received data.
